(19) United States
(12) Patent Application Publication
(10) Pub. No.: US 2012/0260292 A1
(43) Pub. Date: Oct. 11, 2012

(54) REMOTE CONTROL SYSTEM, TELEVISION, REMOTE CONTROLLER AND COMPUTER-READABLE MEDIUM

(75) Inventor: Yasuo Okami, Higashimurayama-shi (JP)

(73) Assignee: CASIO COMPUTER CO., LTD., Tokyo (JP)

(21) Appl. No.: 13/439,998

(22) Filed: Apr. 5, 2012

(30) Foreign Application Priority Data
Apr. 8, 2011 (JP) 2011-086742

(51) Int. Cl. H04N 21/482

(52) U.S. Cl. 725/51; 725/38

(57) ABSTRACT

A remote control system includes a television and a remote controller. The television includes a first transmitter/receiver acquiring web information; a first display displaying a web page based on the web information; and a controller extracting GUI information indicating GUI parts from the web information and sending the GUI information to the remote controller. The remote controller includes a second transmitter/receiver receiving the GUI information from the television; a second display displaying a GUI screen that arranges the GUI parts of the GUI information; and a detecting unit detecting a selection operation by which one of the GUI parts is selected. The second transmitter/receiver sends input information indicating the selected GUI part to the television. The first transmitter/receiver receives the input information from the remote controller. The controller controls the first display to display a screen corresponding to the selected GUI part of the input information.

### CROSS-REFERENCE TO RELATED APPLICATION

This application claims the benefit of Japanese Patent Application No. 2011-086742, filed on Apr. 8, 2011, the entire disclosure of which is incorporated by reference herein.

### FIELD

This application relates to a remote control system, television, remote controller, and computer-readable medium for remotely controlling a television.

### BACKGROUND

In view of the digital television, extensive use of the Internet, diverse video contents on the Internet, television sets with the function of web browsing have been developed.

For web browsing on such a television, the user has to display a GUI screen and conduct GUI operation such as pointing a GUI part. Furthermore, since the user is more or less away from the television to watch it, unlike a conventional computer, operation with a remote control (remote controller) is desired.

Some of the known methods of GUI operation with a remote control are as follows.

The first method of GUI operation consists of key operation on the remote control. More specifically, the cursor key on the remote control is operated to move the mouse cursor on the screen and the buttons on the remote control are used for election and implementation.

The second method of GUI operation consists of use of a special remote control. The remote control of some game machines detects and sends the orientation and tilt of the remote control to the game machine. A mouse cursor is displayed at a position corresponding to the remote control on the television screen to which the game machine is connected. The user moves the remote control to operate the mouse cursor on the screen and conducts operation such as selection and implementation through the buttons on the remote control.

The third method displays on the remote control the same screen (virtual screen) as the one displayed on the television and conveys icon operation on the remote control screen to the television (see Unexamined Japanese Patent Application Publication No. 2010-016734).

The above methods all have particular defects.

In the first method, the buttons on the remote control are operated to move the mouse cursor. It is difficult to operate; therefore, the mouse cursor does not move smoothly. Furthermore, in the case of television viewing, the user conducts operation while viewing the screen at a distance. The user easily loses sight of the mouse cursor, making the operation difficult.

In the second method, the movement and tilt of the remote control is used for pointing; therefore, it is difficult to make small moves. Then, for example, when pointing targets are close to each other, operation errors easily occur. Furthermore, since the operation is conducted at a distance from the television as in the first method, the user easily loses sight of the mouse cursor, making the operation difficult.

In the third method, the virtual screen displayed on the remote control has the same contents as the real screen. The bulky data increases the data transfer time, contributing to lower response performance and operability. Furthermore, the real screen is entirely reduced in size to display it on the remote control screen. The displayed GUI parts are very small, contributing to lower visibility and operability.

### SUMMARY

The present invention is invented in view of the above circumstances and an exemplary object of the present invention is to provide a remote control system, television, remote controller, and computer-readable medium allowing for easy operation on the GUI displayed on a television or the like.

A first aspect of the present invention provides a remote control system comprising a television and a remote controller, wherein: the television comprises: a first transmitter/receiver which acquires web information; a first display which displays a web page based on the web information; and a controller which extracts GUI information indicating GUI parts from the web information and sends the GUI information via the first transmitter/receiver to the remote controller; the remote controller comprises: a second transmitter/receiver which receives the GUI information from the television; a second display which displays a GUI screen that arranges the GUI parts of the GUI information; and a detecting unit which detects a selection operation by which one of the GUI parts is selected, wherein the second transmitter/receiver sends input information indicating the selected GUI part to the television; wherein the first transmitter/receiver receives the input information indicating the selected GUI part from the remote controller; and wherein the controller controls the first display to display a screen corresponding to the selected GUI part of the input information.

A second aspect of the present invention provides a television comprising: a transmitter/receiver which acquires web information; a display which displays a web page based on the web information; and a controller which extracts GUI information indicating GUI parts from the web information and sends the GUI information via the transmitter/receiver to a remote controller; wherein the transmitter/receiver receives input information indicating a GUI part which is selected among the GUI parts by the remote controller; and wherein the controller controls the display to display a screen corresponding to the selected GUI part of the input information.

A third aspect of the present invention provides a remote controller comprising: a transmitter/receiver which receives GUI information indicating GUI parts from a television; a display which displays a GUI screen that arranges the GUI parts of the GUI information; and a detecting unit which detects a selection operation by which one of the GUI parts is selected, wherein the transmitter/receiver further sends input information indicating the selected GUI part to the television.

A fourth aspect of the present invention provides a non-transitory computer-readable medium storing programs including a series of instructions executed by a computer and allowing the computer to implement the following procedures: a web information acquisition procedure to acquire web information; a web page display procedure to display a web page based on the web information; an extraction procedure to extract GUI information indicating GUI parts from the web information; a GUI information transmission procedure to send the GUI information to a remote controller; an input information reception procedure to receive from the remote controller input information indicating a GUI part which is selected among the GUI parts by the remote controller; and a control procedure to control the web page display procedure so as to display a screen corresponding to the selected GUI part of the input information.

### BRIEF DESCRIPTION OF THE DRAWINGS

A more complete understanding of this application can be obtained when the following detailed description is considered in conjunction with the following drawings, in which:

FIG. 1 is a block diagram showing an exemplary configuration of a web-browsable television system according to Embodiment 1 of the present invention;

FIG. 2A is a block diagram showing an exemplary functional configuration of the remote control according to Embodiment 1;

FIG. 2B is a block diagram showing an exemplary hardware configuration of the remote control according to Embodiment 1;

FIG. 3A is a block diagram showing an exemplary functional configuration of the television according to Embodiment 1;

FIG. 3B is a block diagram showing an exemplary hardware configuration of the television according to Embodiment 1;

FIG. 4 is a flowchart showing an exemplary remote control operation of the remote control and television according to Embodiment 1;

FIG. 5 is an illustration showing an exemplary web screen and GUI screen displayed on the television and remote control, respectively, according to Embodiment 1;

FIG. 6 is an illustration showing an exemplary context menu display on the GUI screen according to Embodiment 1;

FIG. 7A is an illustration for explaining the scroll display of a GUI screen according to Embodiment 1;

FIG. 7B is an illustration showing the remote control according to Embodiment 1 when it is tilted away from the user;

FIG. 7C is an illustration showing the remote control according to Embodiment 1 when it is tilted toward the user;

FIG. 8 is a block diagram showing an exemplary configuration of a web-browsable television system according to Embodiment 2 of the present invention;

FIG. 9A is a block diagram showing an exemplary functional configuration of the remote control according to Embodiment 2;

FIG. 9B is a block diagram showing an exemplary hardware configuration of the remote control according to Embodiment 2;

FIG. 10 is a flowchart showing an exemplary remote control operation of the remote control and television according to Embodiment 2;

FIG. 11 is an illustration showing an exemplary remote control screen displayed on the remote control according to Embodiment 2; and

FIG. 12 is an illustration showing an exemplary television selection screen displayed on the remote control according to Embodiment 2.

### DETAILED DESCRIPTION

Television systems comprising the remote control system according to embodiments of the present invention will be described hereafter with reference to the drawings. In the drawings, the same or equivalent components are referred to by the same reference numbers.

### Embodiment 1

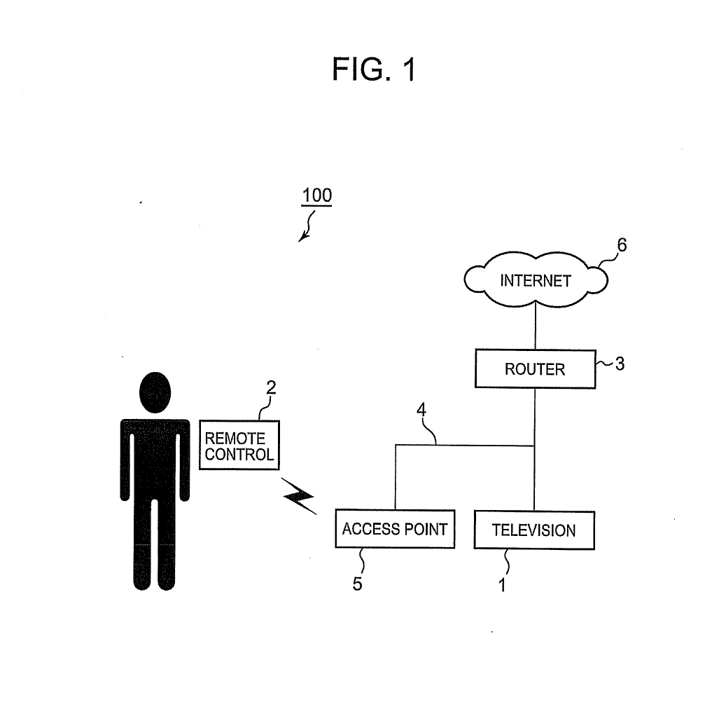

A television system 100 according to Embodiment 1 comprises, as shown in FIG. 1, a television 1, a remote control 2, a router 3, a home LAN 4, and an access point 5. These devices comply with a DLNA (digital living network appliance).

The television (television receiver) 1 has the function of receiving television broadcast via a television tuner and the function of displaying web pages acquired from the Internet 6 via the router 3. The television 1 will be described in detail later.

The remote control (remote controller) 2 is used to send various instruction entered by the user to the television 1. Furthermore, the remote control 2 comprises a display screen to display a screen of GUI parts extracted from the web page displayed on the television 1 and sends information regarding the operated GUI part to the television 1. The remote control 2 will be described in detail later.

The router 3 is a communication device for connecting the home LAN 4 and Internet 6.

The access point 5 is connected to the home LAN 4 and conducts wireless communication with the remote control 2 through a wireless communication means (such as Wi-Fi (registered trademark)) so as to connect the home LAN 4 and remote control 2.

The home LAN 4 connects the television 1, router 3, and access point 5 to each other for data transfer.

In the television system 100 having the above configuration, the remote control system for remotely controlling the television 1 is composed of the television 1, remote control 2, home LAN 4, and access point 5. The remote control system has the functions of extracting the GUI parts in the web page displayed on the television 1, displaying them on the remote control 2, and reflecting the user operation on the GUI parts displayed on the remote control 2 in the television display.

The remote control 2 will be described in detail hereafter with reference to the drawings.

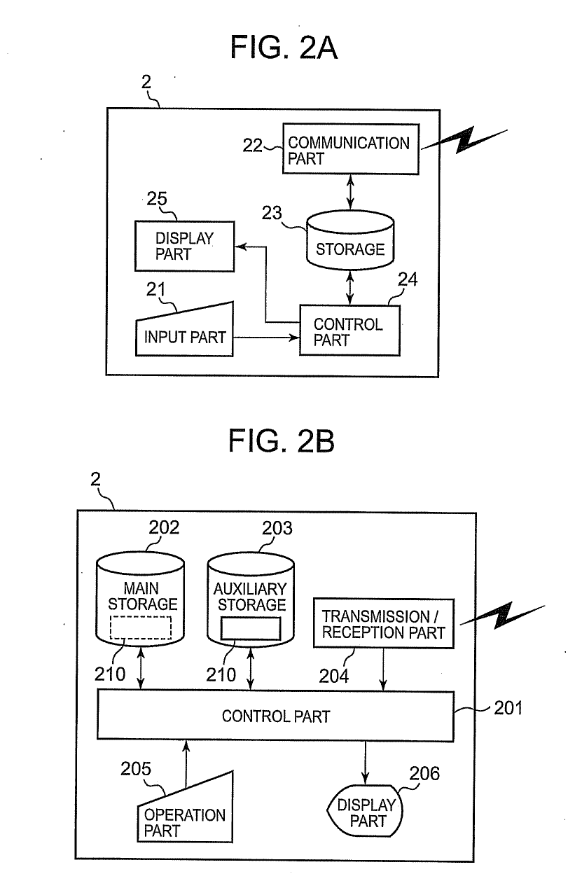

The remote control 2 comprises, from the aspect of function, an input part 21, a communication part 22, a storage 23, a control part 24, and a display part 25 as shown in FIG. 2A.

The input part 21 receives input operation from the user and sends operation information presenting the input operation to the control part 24.

The communication part 22 transmits/receives data to/from a communication part 11 of the television 1, which will be described later, via the access point 5 and home LAN 4.

The storage 23 stores data received by the communication part 22 from the television 1 and data created by the control part 24.

The control part 24 controls the entire remote control 2 for conveying the user operation instruction to the television 1. More specifically, the control part 24 receives GUI information presenting the GUI parts contained in the displayed web page and their positions from the television 1 via the communication part 22. The control part 24 converts the received GUI information to conform to the display part 25 and displays a GUI screen displaying the GUI parts on the display part 25. Furthermore, the control part 24 creates input information presenting the GUI part selected by the user based on operation information received from the input part 21 and sends it to the television 1 via the communication part 22. The control executed by the control part 24 will be described in detail later.

The display part 25 displays various data according to the control of the control part 24.

In order to realize the above functions, the remote control 2 comprises, from the aspect of hardware, a control part 201, a main storage 202, an auxiliary storage 203, a transmission/reception part 204, an operation part 205, and a display part 206 as shown in FIG. 2B. The main storage 202, auxiliary storage 203, transmission/reception part 204, operation part 205, and display part 206 are all connected to the control part 201.

The control part 201 is composed of a processor or the like and operates according to control programs 210 stored in the auxiliary storage 203 to implement various procedures of the control part 24.

The main storage 202 is composed of a RAM (random access memory) or the like. The control part 201 loads the control programs 210 stored in the auxiliary storage 203 onto the main storage 202 and uses it as the work area. The main storage 202 functions as the storage 23.

The auxiliary storage 203 is composed of a nonvolatile memory such as a flash memory and stores programs for the control part 201 to conduct the processing of the remote control 2. Furthermore, the auxiliary storage 203 supplies data for the programs to the control part 201 and stores data supplied from the control part 201 according to the control of the control part 201.

The transmission/reception part 204 is composed of a wireless communication device and conducts wireless communication with the access point 5 to establish connection to the television 1 via the home LAN 4. The transmission/reception part 204 functions as the communication part 22.

The operation part 205 is composed of a touch panel detecting the user's touch or the like and supplies to the control part 201 operation information presenting the position of the user's touch. The operation part 205 functions as the input part 21. Here, the operation part 205 can include a push-type input device such as a numeric keypad, cursor key, or button in addition to the contact-type input device such as a touch panel and touch pad.

The display part 206 is composed of an LCD (liquid crystal display) and displays screens supplied from the control part 201. The display part 206 functions as the display part 25.

Here, the operation part 205 and display part 206 are laminated and configured as a touch panel display.

The television 1 will be described in detail hereafter.

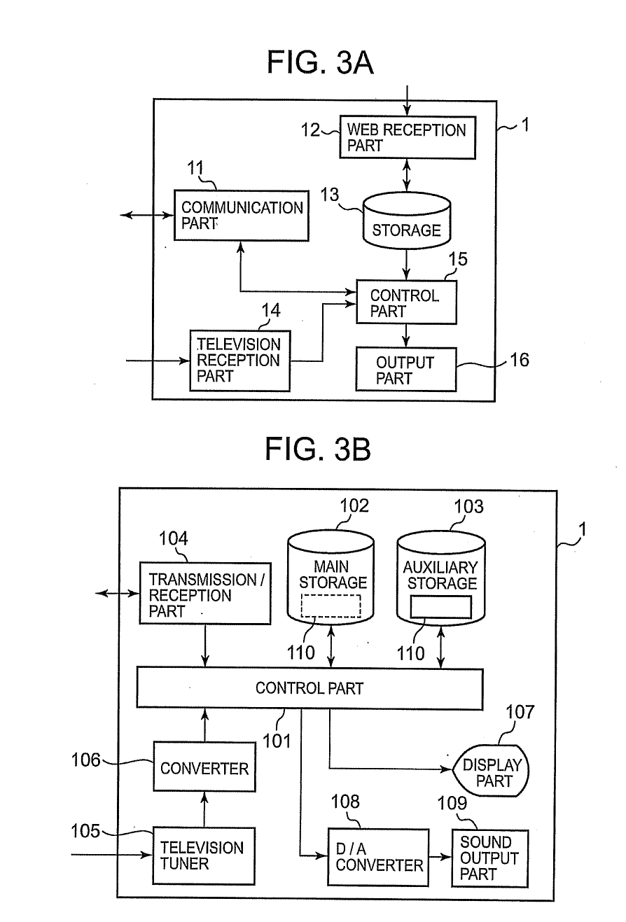

The television 1 is composed of, from the aspect of function, a communication part 11, a web reception part 12, a storage 13, a television reception part 14, a control part 15, and an output part 16 as shown in FIG. 3A.

The communication part 11 transmits/receives data to/from the remote control 2 via the home LAN 4 and access point 5.

The web reception part 12 receives web information from the Internet 6 via the home LAN 4 and router 3 and sends it to the control part 15 under the control of the control part 15. The web information is, for example, various data for displaying web pages such as documents written in HTML or XML (“HTML documents” or “XML documents,” hereafter) and image files.

The storage 13 stores various data for web browsing. The storage 13 further stores a list of tags presenting GUI parts.

The television reception part 14 receives television broadcast via an antenna or cable line, demodulates video/sound signals, and sends them to the control part 15.

The control part 15 switches between the television mode to output television screens to the output part 16 and the web mode to output web screens to the output part 16 and conducts controls accordingly.

In the television mode, the control part 15 outputs to the output part 16 video and sound signals supplied from the television reception part 14. On the other hand, in the web mode, the control part 15 converts web information received by the web reception part 12 from the Internet 6 to conform to the output part 16 and outputs it to the output part 16.

Furthermore, in the web mode, the control part 15 extracts GUI information presenting GUI parts and their positions from web information received by the web reception part 12, and sends it to the remote control 2 via the communication part 11. More specifically, the control part 15 makes reference to a list of tags presenting GUI parts stored in the storage 13, and detects the tags presenting the GUI parts in an HTML document or XML document contained in the web information received by the web reception part 12. Then, the control part 15 extracts GUI information presenting the GUI parts and their positions.

Receiving input information from the remote control 2 via the communication part 11, the control part 15 creates a screen corresponding to the GUI part selected by the user.

For example, if the GUI part selected by the user is associated with a link, the control part 15 instructs the web reception part 12 to receive web information of the web page of the link. The control part 15 outputs to the output part 16 the web information received by the web reception part 12. On the other hand, if the GUI part selected by the user is a button or icon, the control part 15 reads necessary data from the storage 13 and creates a screen corresponding to the GUI part with which no link is associated. The operation of the control part 15 will be described in detail later.

The output part 16 outputs television pictures and sound or web images and sound under the control of the control part 15.

The hardware configuration of the television 1 having the above functional configuration will be described hereafter with reference to FIG. 3B. As shown in the figure, the television 1 comprises, from the aspect of hardware, a control part 101, a main storage 102, an auxiliary storage 103, a transmission/reception part 104, a television tuner 105, a converter 106, a display part 107, a D/A (digital/analog) converter 108, and a sound output part 109. The main storage 102, auxiliary storage 103, transmission/reception part 104, converter 106, display part 107, and D/A (digital/analog) converter 108 are all connected to the control part 101.

The control part 101 is composed of a processor or the like and executes the procedures implemented by the above-described control part 15 according to control programs 110 stored in the auxiliary storage 103. The control part 101 processes picture (image) data and sound data received from the converter 106 or transmission/reception part 104 and sends them to the display part 107 and D/A converter 108.

The main storage 102 is composed of a RAM (random access memory) or the like. The control part 101 loads the control programs 110 stored in the auxiliary storage 103 onto the main storage 102 and uses it as the work area.

The auxiliary storage 103 is composed of a nonvolatile memory such as a flash memory, hard disc, DVD-RAM (digital versatile disc random access memory), and DVD-RW (digital versatile disc rewritable), and stores programs for the control part 101 to conduct the processing of the television 1. Furthermore, the auxiliary storage 103 supplies data stored in the programs to the control part 101 and stores data supplied from the control part 101 according to the control of the control part 101. The main storage 102 and auxiliary storage 103 function as the storage 13.

The transmission/reception part 104 is composed of an LAN interface connecting to the access point 5 and router 3 and to the home LAN 4 to which they are connected. The transmission/reception part 104 is connected to the remote control 2 through wireless communication and transmits/receives data to/from the remote control 2. Furthermore, the transmission/reception part 104 is connected to the Internet and receives web information. The transmission/reception part 104 supplies the received web information to the control part 101. The transmission/reception part 104 functions as the communication part 11 and web reception part 12.

The television tuner 105 receives television airwaves (NTSC signals) via an antenna and sends them to the converter 106.

The converter 106 converts the NTSC signals (picture signals) to RGB signals and supplies them to the control part 101. Furthermore, the converter 106 converts the NTSC signals (sound signals) to digital signals and supplies them to the control part 101. The television tuner 105 and converter 106 function as the television reception part 14.

The display part 107 is composed of a CRT (cathode ray tube), an LCD (liquid crystal display), or the like, and displays screens supplied from the control part 101. The display part 107 functions as the output part 16.

The D/A conversion part 108 converts digital sound signals supplied from the control part 101 to analog signals and sends them to the sound output part 109. The D/A conversion part 108 functions as the control part 15.

The sound output part 109 is composed of an audio amplifier, a speaker, and the like and outputs sound supplied from the D/A conversion part 108. The sound output part 109 functions as the output part 16.

The procedures implemented by the control part 15, communication part 11, television reception part 14, web reception part 12, storage 13, and output part 16 of the television 1 shown in FIG. 3A are executed by the control part 101 shown in FIG. 3B according to the control programs 110 with the use of the main storage 102, auxiliary storage 103, transmission/reception part 104, television tuner 105, converter 106, display part 107, D/A converter 108, and sound output part 109 as resources.

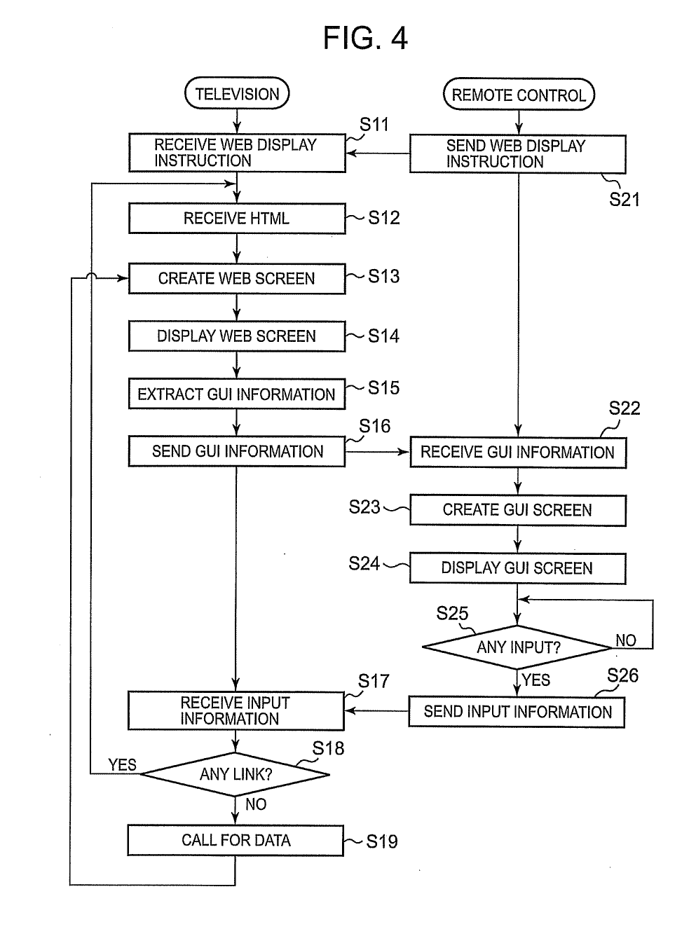

An exemplary remote control operation of the remote control 2 and television 1 will be described hereafter with reference to the flowchart of FIG. 4. The television 1 switches between the television mode to output television screens and the web mode to output web screens. This embodiment exploits its characteristics when the television 1 is in the web mode. Therefore, the case in which the television operates in the web mode will be described with reference to FIG. 4.

First, as the user of the remote control 2 enters an instruction to switch the television 1 from the television mode to the web mode, the control part 24 sends input information indicating that the user has entered an instruction to switch from the television mode to the web mode (“web display instruction” in the figure) to the television 1 via the communication part 22 (Step S21). Here, the instruction to switch from the television mode to the web mode is entered, for example, by selecting a web display button on the remote control 2. The web display button can be displayed on the touch panel display and touched by the user to select it, or provided as a push button and pressed by the user to select it.

As the communication part 11 of the television 1 receives the web display instruction from the communication part 22 of the remote control 2 as controlled by the control part 15 (Step S11), the control part 15 switches from the television mode to the web mode. After switched to the web mode, the web reception part 12 receives web information of a web page corresponding to the web display instruction from the Internet as controlled by the control part 15 (Step S12). For example, an initial web page screen is set on the web display button in advance. The control part 15 converts the web information received by the web reception part 12 to conform to the output part 16 and creates a web screen (Step S13). The output part 16 displays the web screen created by the control part 15 as controlled by the control part 15 (Step S14).

Furthermore, the control part 15 extracts GUI information presenting GUI parts and their positions from the web information received by the web reception part 12 (step S15). The communication part 11 sends the GUI information extracted by the control part 15 to the remote control 2 as controlled by the control part 15 (Step S16).

The communication part 22 of the remote control 2 receives the GUI information from the communication part 11 of the television 1 as controlled by the control part 24 (Step S22), and sends it to the control part 24. The control part 24 converts the GUI information received from the communication part 22 to conform to the display part 25 and creates a GUI screen displaying the GUI parts (Step S23). The display part 25 displays the GUI screen created by the control part 24 as controlled by the control part 24 (Step S24).

If the user conducts input operation on the GUI screen displayed on the display part 25 by touching the input part 21(Step S25; YES), the input part 21 acquires operation information presenting the touch position as controlled by the control part 24 and sends it to the control part 24. The control part 24 identifies the GUI part touched by the user based on the operation information received from the input part 21 and the GUI screen stored in the storage 23. The control part 24 sends input information indicating that the user has selected the identified GUI part to the television 1 via the communication part 22 (Step S26). If the user does not conduct any input operation on the GUI screen displayed on the display part 25 (Step S25; NO), the step 25 is repeated while waiting for input operation of the user.

The communication part 11 of the television 1 receives the input information from the communication part 22 of the remote control 2 as controlled by the control part 15 (Step S17) and sends it to the control part 15. The control part 15 determines whether the GUI part selected by the user is associated with a link based on the input information received from the communication part 11 (step S18). If it is associated with a link (Step S18; YES), the control part 15 returns to the Step S12. The web reception part 12 receives web information of a web page corresponding to the link from the Internet as controlled by the control part 15 and repeats the Steps S12 to S18. Consequently, the web screen displaying the web page that is set for the GUI part selected by the user is displayed on the output part 16.

On the other hand, if it is not associated with a link (Step S18; NO), the control part 15 reads data necessary for displaying a screen corresponding to the GUI part from the storage 13 (Step S19) and returns to the Step S13. The control part 15 creates a screen corresponding to the GUI part based on the data read from the storage 13 and repeats the Steps S13 to S18. Consequently, the screen corresponding to the GUI part selected by the user is displayed on the output part 16.

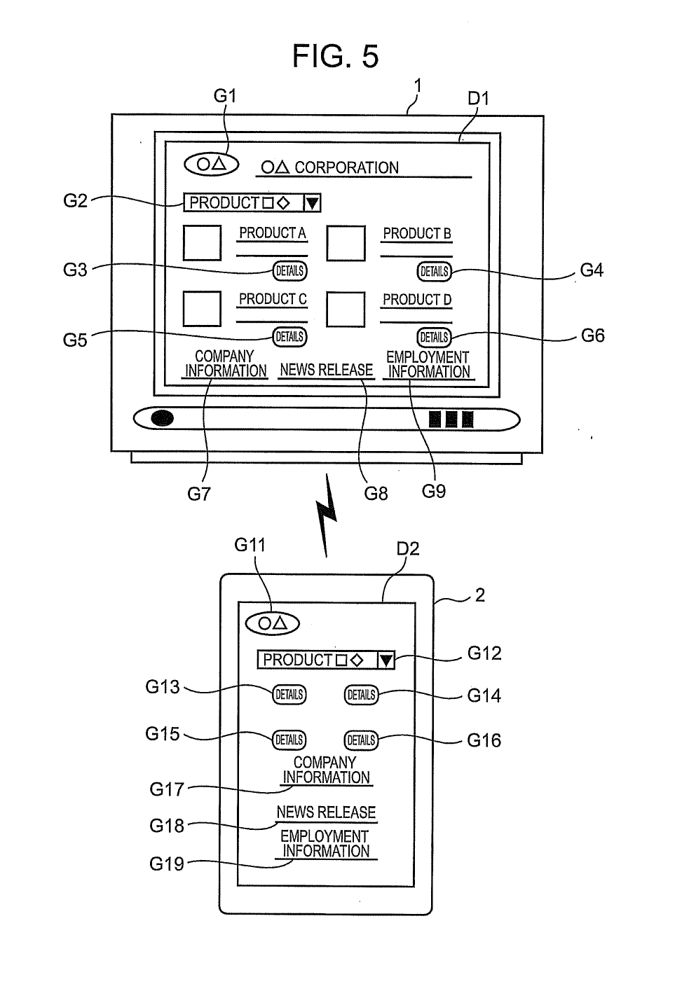

The exemplary web screen and GUI screen displayed on the television 1 and remote control 2, respectively, shown in FIG. 5 will be described hereafter with reference to the flowchart of FIG. 4.

The control part 15 converts the web information of a website of a company ∘Δ received by the web reception part 12 to conform to the output part 16 and creates a web screen D1 displaying the website of the company ∘Δ (Step S13). The output part 16 displays the web screen D1 created by the control part 15 as controlled by the control part 15 (Step S14).

The web screen D1 contains the following GUI parts: a logo image G1 of the company ∘Δ that is associated with the link to the top page of the company ∘Δ; a drop down list G2 of products; a detail button G3 that is associated with the link to the product detail page for a product A; a detail button G4 that is associated with the link to the product detail page for a product B; a detail button G5 that is associated with the link to the product detail page for a product C; a detail button G6 that is associated with the link to the product detail page for a product D; text G7 reading “Company Information” that is associated with the link to the company information page of the company ∘Δ; text G8 reading “News Release” that is associated with the link to the news release page of the company ∘Δ; and text G9 reading “Employment Information” that is associated with the link to the employment information page of the company ∘Δ.

The control part 15 makes reference to a list of tags presenting GUI parts stored in the storage 13, detects the tags presenting the GUI parts within the HTML document contained in the web information of the website of the company ∘Δ received by the web reception part 12, and extracts GUI information presenting the GUI parts G1 to G9 and their positions (Step S15). The communication part 11 sends the GUI information to the remote control 2 as instructed by the control part 15 (Step S16).

As the communication part 22 of the remote control 2 receives the GUI information from the television 1 (Step S22), the control part 24 changes the GUI parts G1 to G9 in size and position to conform to the display part 25 based on the GUI information and creates a GUI screen D2 displaying GUI parts G11 to G19 (Step S23). The display part 25 displays the GUI screen D2 as instructed by the control part 24 (Step S24).

The GUI screen D2 contains the following GUI parts: a logo image G11 corresponding to the logo image G1; a drop down list G12 corresponding to the drop down list G2; a detail button G13 corresponding to the detail button G3; a detail button G14 corresponding to the detail button G4; a detail button G15 corresponding to the detail button G5; a detail button G16 corresponding to the detail button G6; text G17 corresponding to the text G7; text G18 corresponding to the text G8; and text G19 corresponding to the text G9.

For example, if the user touches the detail button G13 contained in the GUI screen D2 of FIG. 5 (Step S25; YES), the control part 24 sends input information indicating that the user has selected the detail button G13 to the television 1 via the communication part 22 (Step S26).

As the communication part 11 of the television 1 receives the input information (Step S17), the control part 15 determines that a link is associated with the detail button G3 corresponding to the detail button G13 (Step S18; YES), and instructs the web reception part 12 to receive a web page of the link associated with the detail button G3 corresponding to the detail button G13 based on the input information, namely web information of the product detail page for a product A (Step S12). The control part 15 converts the web information received by the web reception part 12 to conform to the display part 16, creates a web screen displaying the product detail page for a product A (Step S13), and displays the web screen on the display part 16 (Step S14).

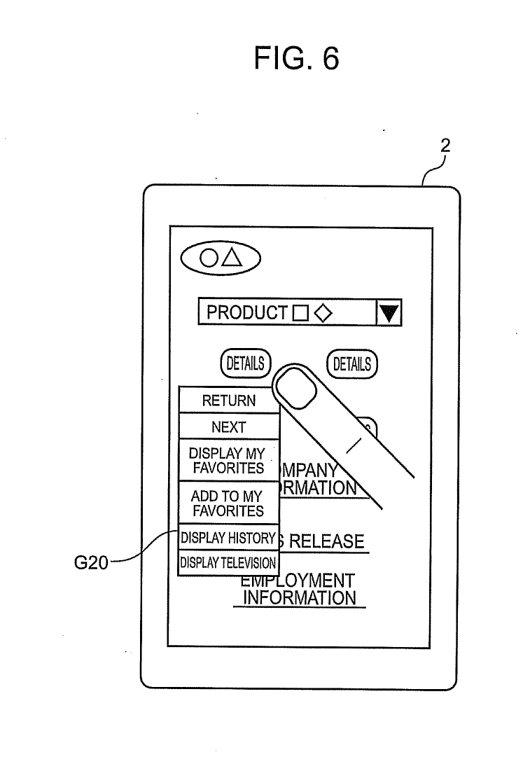

Here, it is possible to display a context menu G20 as shown in FIG. 6 if the user touches somewhere on the GUI screen D2 where nothing is displayed. Alternatively, it is possible to display the context menu G20 if the user touches somewhere on the GUI screen D2 two times successively within a given time period (for example, one second). The context menu G20 is a list of commands for various conventional web browser functions such as “return,” “next,” “display my favorites,” “add to my favorites,” and “display history,” and “display television” for sending a television display instruction to the television 1 to switch from the web mode to the television mode.

The case in which the user has selected a command on the context menu of FIG. 6 will be described hereafter with reference to the flowchart of FIG. 4. For example, if the user has selected the command “display my favorites” on the context menu G20 of FIG. 6 (Step S25; YES), the control part 24 of the remote control 2 sends input information indicating that the user has selected the command “display my favorites” to the television 1 via the communication part 22 (Step S26).

As the communication part 11 of the television 1 receives the input information (Step S17), the control part 15 determines that there is no link associated with the command “display my favorites” (Step S18; NO), and reads information presenting “my favorites” stored in the storage 13 based on the input information (Step S19), creates a screen displaying information presenting “my favorites,” and displays the screen on the output part 16 (Step S13).

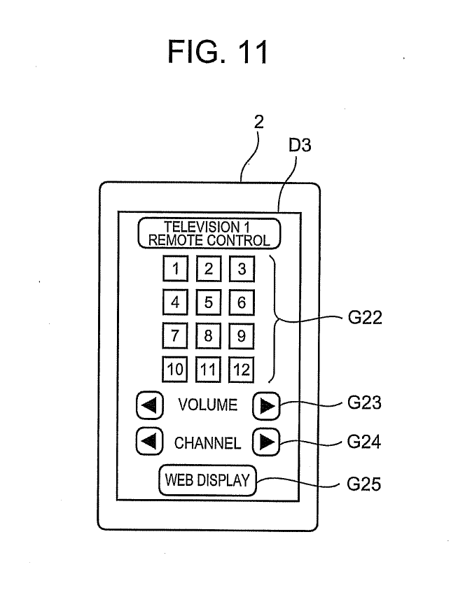

If the user has selected the command “display television” on the context menu G20 of FIG. 6, the control part 24 of the remote control 2 sends input information indicating that the user has selected the command “display television” to the television 1 via the communication part 22. As the communication part 11 of the television 1 receives the input information indicating that the command “display television” is selected, the control part 15 switches to the television mode. It is recommended that the communication part 24 of the remote control 2 displays a remote control screen as shown FIG. 11 on the display part 25 while the television 1 is in the television mode.

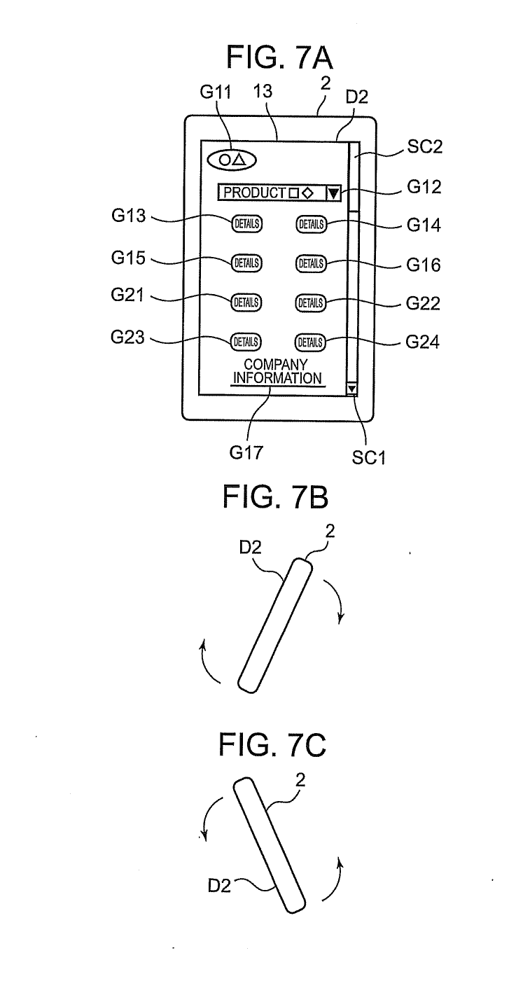

In the event that not all GUI parts contained in the GUI screen D2 created by the control part 24 appear on a screen, the display content can be scrolled. Scroll display of a GUI screen will be described with reference to FIG. 7. For scrolling, as shown in FIG. 7A, a scroll button SC1 is pressed or a scroll bar SC2 is dragged to move it.

Alternatively, the remote control 2 is provided with a three-axis sensor that detects the orientation and tilt of the remote control for scrolling. In such a case, the GUI screen D2 is scrolled down as the user tilts the remote control 2 away from him/her as shown in FIG. 7B and the GUI screen D2 is scrolled up as the user tilts the remote control 2 toward him/her as shown in FIG. 7C.

As described above, the remote control system according to Embodiment 1 can provide a GUI operation technique granting high operability through a remote control. Furthermore, the remote control system according to Embodiment 1 can provide a remote control technique facilitating the operation on the GUI displayed on a television or the like.

When the user is more or less away from the screen and conducts GUI operation, the remote control system of Embodiment 1 allows the user to operate on the GUI screen displayed on the remote control in his/her hand, instead of operating while viewing the screen at a distance, whereby the operability is not lowered. Furthermore, the GUI screen displays only the GUI parts extracted from the web page displayed on the television 1. Screen data for remote control display can be reduced. Then, the data transfer time is expected to be reduced.

### Embodiment 2

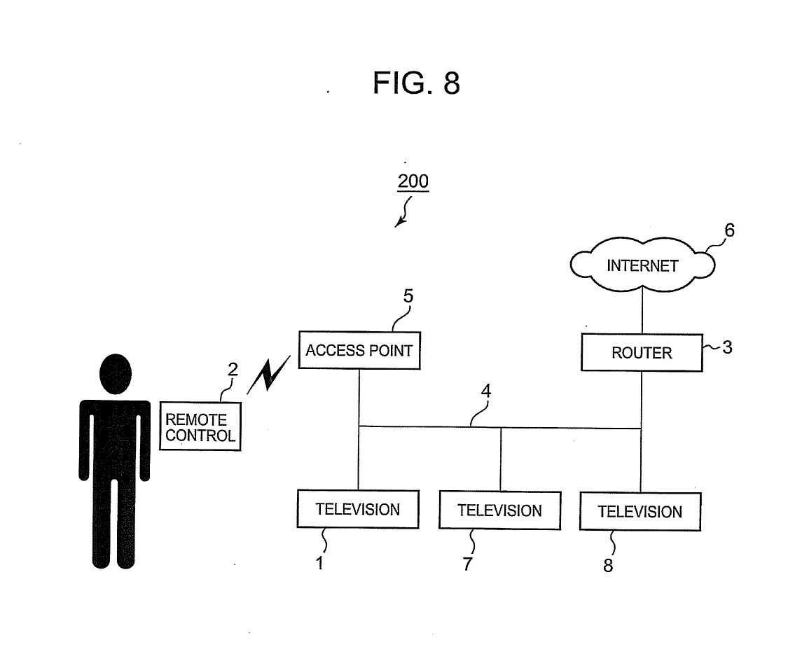

In a television system 200 of Embodiment 2, as shown in FIG. 8, a television (television receiver) 7 and a television (television receiver) 8 are added to the television system 100. The televisions 7 and 8 have the same function as the television 1 and are connected to the home LAN 4. Here, there are three televisions in Embodiment 2 by way of example; one or more televisions can sufficiently be provided.

In the television system 200 having the above configuration, the remote control system for remotely controlling the televisions 1, 7, and 8 is composed of the televisions 1, 7, and 8, remote control 2, home LAN 4, and access point 5. The remote control 2 is capable of detecting a television 1, 7, or 8 and identifying it.

The remote control 2 will be described in detail hereafter with reference to the drawings.

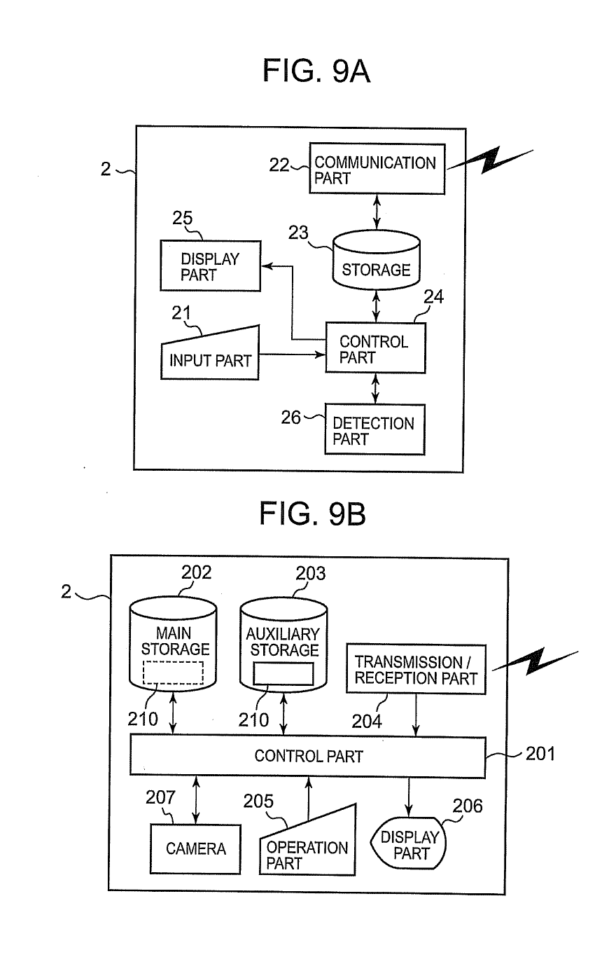

The remote control 2 comprises, from the aspect of function, an input part 21, a communication part 22, a storage 23, a control part 24, a display part 25, and additionally a detection part 26 as shown in FIG. 9A.

The detection part 26 acquires an image in a given direction and analyzes the acquired image to detect the presence of a television. Detecting the presence of a television, the detection part 26 compares the images of the televisions stored in the storage 23 with the acquired image and determines which television it is.

The storage 23 stores the television images and remote control screens of the televisions.

Here, the television 1 has the same function as the one in Embodiment 1 and the televisions 7 and 8 has the same function as the television 1.

In order to realize the above function, the remote control 2 comprises, from the aspect of hardware, a control part 201, a main storage 202, an auxiliary storage 203, a transmission/reception part 204, an operation part 205, a display part 206, and additionally a camera 207 as shown in FIG. 9B. Like the main storage 202, auxiliary storage 203, transmission/reception part 204, operation part 205, and display part 206, the camera 207 is also connected to the control part 201.

The camera 207 is provided at the top or on the back of the remote control 2 and captures images of the space in front. The camera 207 supplies the captured images to the control part 201. As the user points the camera 201 at a television, the camera 207 can acquire an image of the television.

The control part 201 analyzes the image supplied from the camera 207 and determines whether a television is present in the imaged space. Furthermore, the control part 201 reads the television images stored in the auxiliary storage 203, compares them with the image supplied from the camera 207, and determines whether they match to identify the television. The camera 207 and control part 201 function as the detection part 26.

Identifying the detected television, the control part 201 reads the remote control screen of the television stored in the auxiliary storage 203 and displays it on the display part 206. The display part 206 displays the remote control screen supplied from the control part 201 as controlled by the control part 201.

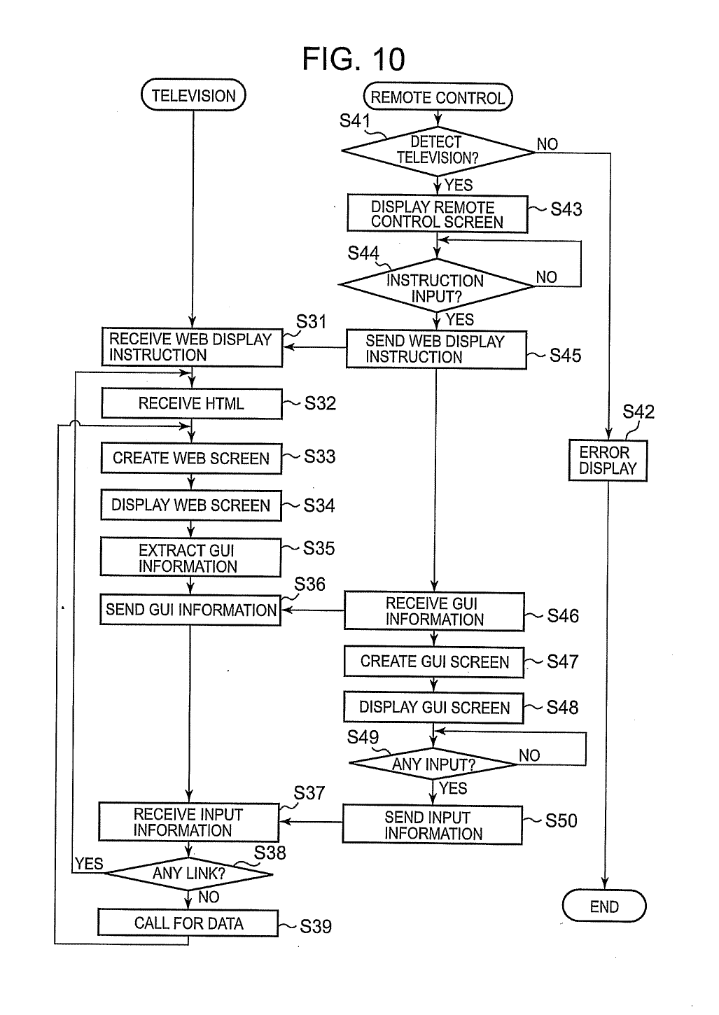

Here, an exemplary remote control operation of the remote control 2 and television 1 according to Embodiment 2 will be described with reference to the flowchart of FIG. 10. First, as the user activates the remote control 2, the detection part 26 acquires an image in a given direction and analyzes the captured image to detect the presence of a television (Step S41).

If the detection part 26 does not detect the presence of a television (Step S41; NO), the control part 24 display an error on the display part 25 (Step S42) and ends the procedure. On the other hand, if the detection part 26 detects the presence of a television (Step S41; YES), the detection part 26 compares the television images stored in the storage 23 with the captured image to determine which television it is. The control part 24 reads the remote control screen of the television identified by the detection part 26 from the storage 23 and displays it on the display part 25 (Step S43).

As the user enters an instruction to switch from the television mode to the web mode (Step S44; YES), the control part 24 sends input information indicating that the user has entered an instruction to switch from the television mode to the web mode (“web display instruction” in the figure) to the television 1 via the communication part 22 (Step S45). If the user does not enter an instruction to switch from the television mode to the web mode (Step S44; NO), the control part 24 repeats the step S44 while waiting for input of an instruction to switch from the television mode to the web mode.

Steps S45 to S50 on the remote control are the same as the Steps S21 to S26 of FIG. 4. Steps S31 to S39 on the television are the same as the Steps S11 to S19 of FIG. 4.

An exemplary remote control screen displayed on the remote control 2 shown in FIG. 11 will be described hereafter with reference to the flowchart of FIG. 10. As the user points the remote control at the television 1 and activates it, the detection part 26 captures an image of the television 1, analyzes the captured image, and detects the presence of the television 1 (Step S41; YES). Then, the detection part 26 compares the television images stored in the storage 23 with the captured image and identifies the television 1. The control part 24 reads the remote control screen of the television 1 identified by the detection part 26 from the storage 23and displays it on the display part 25 (Step S43).

A remote control screen D3 of the television 1 contains the following GUI parts: channel buttons G22 specifying a channel on the television screen; volume keys G23 changing the sound volume of the sound of the television screen; channel keys G24 changing the channel on the television screen; and a web display button G25 switching the television mode to the web mode. For example, as the user of the remote control 2 presses the web display button G25 on the remote control screen D3 (Step S44; YES), the control part 24 sends a web display instruction to the television 1 via the communication part 22 (Step S45).

As described above, the remote control system of Embodiment 2 detects and identifies the television and establishes connection to the television as the user simply points the camera of the remote control at the television. Consequently, the user's workload is reduced.

In Embodiment 1, the remote control 2 and television 1 transmit/receive data through DLNA data transfer. However, the present invention is not restricted thereto. A RDP (remote desktop protocol) can be used. Furthermore, a HTTP (hypertext transfer protocol) or RPC (remote procedure call), or any other TCP/IP based protocol can be used.

In Embodiment 1, the control part 24 of the remote control 2 converts GUI information to conform to the display part 25. However, the present invention is not confined thereto. The control part 25 of the television 1 can conduct the conversion.

In Embodiment 1, television airwaves received by the television tuner 105 via an antenna are analog airwaves (NTSC signals). However, the present invention is not confined thereto. Digital airwaves can be received.

In Embodiment 2, the detection part 26 acquires an image, compares it with the television images stored in the storage 23 to detect and identify the television. However, the present invention is not confined thereto. The detection part 26 may detect the presence of a television by synchronization using a Bluetooth (registered trademark). In such a case, the detection part 26 receives identification information from a television through Bluetooth communication. Then, the detection part 26 determines which television it is based on television identification information stored in the storage 23. In this way, it is possible to detect and identify the television and establish connection to the television as long as the remote control held by the user is present within a wireless communication range of the television.

When the remote control 2 detects the presence of a television by synchronization using Bluetooth (registered trademark), the remote control 2, television 1, and televisions 7 and 8 are provided with a Bluetooth communication device. Once Bluetooth connection is established, the Bluetooth communication device of the remote control 2 receives identification information from the connected television and supplies it to the control part 201. Supplied with the television identification information from the Bluetooth communication device, the control part 201 determines that there is a television. Then, the control part 201 reads television identification information stored in the auxiliary storage 203 and identifies the television by determining whether they match the television identification information supplied from the Bluetooth communication device.

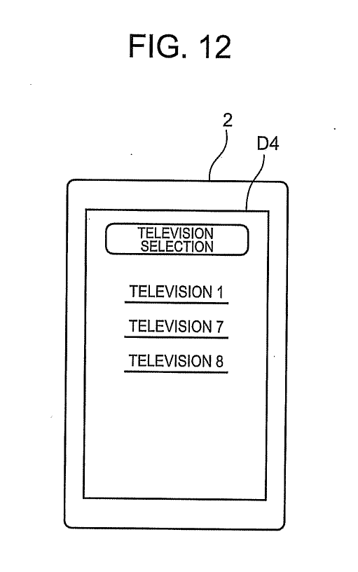

In Embodiment 2, as the remote control 2 is activated, the detection part 26 detects the present of a television and identifies the detected television. However, the present invention is not confined thereto. It is possible to display a television selection screen D4 as shown in FIG. 12 as the remote control 2 is activated; then, the detection part 26 detects the presence of a television selected by the user.

In such a case, the storage 23 stores the television selection screen D4 as shown in FIG. 12. For example, if the user selects the television 1 on the television selection screen D4, the detection part 26 activates the camera 207 and acquires an image of the space in front. If the user is pointing the camera 207 at the television 1, the detection part 26 detects the presence of the television 1 as a result of analyzing the acquired image. Then, the detection part 26 compares the image of the television 1 stored in the storage 23 with the acquired image and determines whether it is the television 1. If the detection part 26 determines that it is not the television 1, the control part 24 displays an error on the display part 206. If the detection part 26 determines that it is the television 1, the control part 24 reads the remote controller screen D3 of the television 1 as shown in FIG. 11 from the storage 23 and displays it on the display part 206.

The remote control of the present invention is applicable to cell-phones and portable terminals such as PDAs.

The above-described hardware configurations and flowcharts are given by way of example and any change and modification can be made.

Here, the core part for the remote controlling, which is composed of the control part 101, main storage 102, auxiliary storage 103, transmission/reception part 104, display part 107, A/D conversion part 108, sound output part 109, control part 201, main storage 202, auxiliary storage 203, transmission/reception part 204, operation part 205, display part 206, and so on, can be realized by a conventional computer system, instead of a dedicated system.

For example, computer programs for implementing the above-described operations can be stored and distributed on a computer-readable storage medium (a flexible disc, CD-ROM, DVD-ROM, etc.) and installed on a computer to configure the remote control 2 and television 1, 7, or 8 implementing the above-described procedures. Alternatively, the computer programs can be stored in a storage device of a server unit on a communication network such as the Internet and downloaded by a conventional computer system to configure the remote control system.

Furthermore, if the functions of the remote control system are realized by apportionment between an OS (operation system) and application programs or by cooperation of an OS and application programs, only the application programs can be stored on a recording medium or storage.

Furthermore, the computer programs can be superimposed on carrier waves and distributed via a communication network. For example, the computer programs can be posted on a bulletin board system (BBS) on a communication network to distribute them via the network. Then, the computer programs are activated and executed as other application programs under the control of an OS to implement the above procedures.

Although several embodiments of the present invention are described above, the present invention is included in the invention set forth in the scope of claims and its equivalent scope.

Having described and illustrated the principles of this application by reference to one (or more) preferred embodiment(s), it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A remote control system comprising a television and a remote controller, wherein:
the television comprises:
a first transmitter/receiver which acquires web information;
a first display which displays a web page based on the web information; and
a controller which extracts GUI information indicating GUI parts from the web information and sends the GUI information via the first transmitter/receiver to the remote controller;
the remote controller comprises:
a second transmitter/receiver which receives the GUI information from the television;
a second display which displays a GUI screen that arranges the GUI parts of the GUI information; and
a detecting unit which detects a selection operation by which one of the GUI parts is selected,
wherein the second transmitter/receiver sends input information indicating the selected GUI part to the television;
wherein the first transmitter/receiver receives the input information indicating the selected GUI part from the remote controller; and
wherein the controller controls the first display to display a screen corresponding to the selected GUI part of the input information.

2. The remote control system according to claim 1, wherein:
the GUI parts include a context menu indicating a list of commands;
the second display displays the context menu under a given condition; and
the controller controls the first display to display a screen corresponding to an arbitrary one of the commands when the first transmitter/receiver receives from the remote controller command information indicating that the arbitrary one of the commands on the context menu is selected.

3. The remote control system according to claim 1, wherein:
the remote controller further includes a detector which detects an orientation and a tilt of the remote controller; and
the second display scrolls the GUI screen based on the orientation and the tilt detected by the detector.

4. The remote control system according to claim 1, wherein:
the remote controller further comprises a detector detecting the television; and
the second display displays a remote control screen corresponding to the detected television when the detector detects the television.

5. The remote control system according to claim 4, wherein:
the detector acquires an image in a given direction, compares the acquired image with an image of the television stored in advance, and identifies the television.

6. The remote control system according to claim 4, wherein:
the detector acquires from the television identification information for identifying the television via wires communication, and identifies the television based on the identification information.

7. A television comprising:
a transmitter/receiver which acquires web information;
a display which displays a web page based on the web information; and
a controller which extracts GUI information indicating GUI parts from the web information and sends the GUI information via the transmitter/receiver to a remote controller;
wherein the transmitter/receiver receives input information indicating a GUI ₚart which is selected among the GUI parts by the remote controller; and
wherein the controller controls the display to display a screen corresponding to the selected GUI part of the input information.

8. A remote controller comprising:
a transmitter/receiver which receives GUI information indicating GUI parts from a television;
a display which displays a GUI screen that arranges the GUI parts of the GUI information; and
a detecting unit which detects a selection operation by which one of the GUI parts is selected,
wherein the transmitter/receiver further sends input information indicating the selected GUI part to the television.

9. A non-transitory computer-readable medium storing programs including a series of instructions executed by a computer and allowing the computer to implement the following procedures:
a web information acquisition procedure to acquire web information;
a web page display procedure to display a web page based on the web information;
an extraction procedure to extract GUI information indicating GUI parts from the web information;
a GUI information transmission procedure to send the GUI information to a remote controller;
an input information reception procedure to receive from the remote controller input information indicating a GUI part which is selected among the GUI parts by the remote controller; and
a control procedure to control the web page display procedure so as to display a screen corresponding to the selected GUI part of the input information.
